(19) United States
(12) Patent Application Publication
(10) Pub. No.: US 2003/0163701 A1
(43) Pub. Date: Aug. 28, 2003

(54) Method and apparatus for public key cryptosystem

(75) Inventors: Yasushi Ochi, Yokohama (JP); Hiroyoshi Tsuchiya, Yokosuka (JP)

Correspondence Address: Townsend and Townsend and Crew LLP, Two Embarcadero Center, 8th Floor, San Francisco, CA, 94111, US

(73) Assignee: Hitachi, Inc., Tokyo (JP)

(21) Appl. No.: 10/376,651

(22) Filed: Feb. 26, 2003

(30) Foreign Application Priority Data
Feb. 27, 2002 (JP) 2002-051978

(51) Int. Cl. H04L 9/00

(52) U.S. Cl. 713/175

(57) ABSTRACT

A method for operating a cryptosystem having a user, a registration station, and an authentication station is disclosed. The user has been assigned an active key pair. The active key pair includes a private key and a public key. The method includes generating an at least one new security key for the user upon receiving a request to generate the at least one new security key. The generated new security key is stored in a storage area without activating the new security key, the new security key being stored as an auxiliary key for the user. A request to activate the new security key that is stored in the storage area is received from the user. The new security key for the user is activated after receiving the activation request from the user.

### CROSS-REFERENCES TO RELATED APPLICATIONS

The present application is related to and claims priority from Japanese Patent Application No. 2002-051978, filed on Feb. 27, 2002.

### BACKGROUND OF THE INVENTION

The present invention relates to a method for using a security key employed in a cryptosystem.

With the expanding and upgrading public key infrastructure (PKI), various services by use of electronic signatures are on the way to full-scale operation. Registration stations responsible for identifying a user and verifying the authenticity of submitted information, which are both necessary to issue a digital certificate, are being established in many places, together with authentication stations for actually issuing the digital certificate.

The following describes a general procedure for issuing a digital certificate used as a registration certificate for the public key, which a user wants to use. The user generates and stores the public key using a personal computer, and then transmits it to a server employed by a registration station (hereinafter referred to as a registration station server) through communication means such as the Internet. The user also submits documents required for an examination for the above verification, such as a certified copy of register and a seal registration certificate, to the registration station by mail. Receiving the public key, the registration station examines the documents, and if there are no problems with them, the registration station transmits the public key to an authentication station through communication means and asks the authentication station to issue the digital certificate.

A server employed by the authentication station (hereinafter referred to as an authentication station server) generates the digital certificate for the public key transmitted from the registration station server, and transmits it to the registration station server. Upon receiving the digital certificate, the registration station server transmits the digital certificate to the user terminal as well as storing it internally. Then, the user can use the public key with the digital certificate attached thereto.

It should be noted that the so-called key pair made up of a public key and a secret or private key may be generated on a personal computer by the user, as described above. Or alternatively, the user may ask the registration station to generate it. In the latter case, the key pair is transmitted from the registration station to the user at the final stage, together with the above digital certificate.

However, due to the nature of the public key cryptosystem, the key pair, made available as described above, becomes more and more risky to use as the frequency and period of its use increase. When it has become no longer possible to securely use the key pair because of increased risk, the user must invalidate the current public key and switch to a new public key.

However, applying for a digital certificate for the new public key simply after the invalidation of the current key causes a time lag between the application and the issuance of the new public key because the user must follow a time consuming procedure for issuing (receiving) the new public key (i.e. generation of a public key, examination by the registration station, and issuance of the certificate). Especially, the examination process requires considerable time, as described above. This means that no public key is available to the user for a considerable period of time until the new public key is issued.

### BRIEF SUMMARY OF THE INVENTION

One embodiment of the present invention provides a method for using a registration station server, which realizes a mechanism in which it is possible to quickly switch to a new public key after invalidation of the current public key while reducing the cost for issuing redundant digital certificates and managing redundant public keys.

In one embodiment, a method for operating a cryptosystem having a user, a registration station, and an authentication station is disclosed. The user has been assigned an active key pair. The active key pair includes a private key and a public key. The method includes generating an at least one new security key for the user upon receiving a request to generate the at least one new security key. The generated new security key is stored in a storage area without activating the new security key, the new security key being stored as an auxiliary key for the user. A request to activate the new security key that is stored in the storage area is received from the user. The new security key for the user is activated after receiving the activation request from the user.

In another embodiment, a registration apparatus provided in a cryptosystem is disclosed. The cryptosystem includes a plurality of user terminals. A network couples the user terminals to the registration apparatus. The apparatus includes a network interface coupled to the network; a database including information about a plurality of users and a plurality of key pairs assigned to the plurality of users; and a computer readable medium. The medium includes code for receiving a first request to initiate registration of an auxiliary key for one of the users at the registration station at a first point in time, the first request not providing an authority to proceed with obtaining a registration certificate of the auxiliary key; and code for receiving a second request at the registration station at a second point in time that is subsequent to the first point in time, the second request providing the authority to obtain the registration certificate of the auxiliary key.

In another embodiment, a method for operating a cryptosystem having a user, a registration station, and an authentication station is disclosed. The user has been assigned an active key pair, the active key pair including a private key and a public key. The method comprises receiving a first request to initiate registration of an auxiliary key for the user at the registration station at a first point in time, the first request not providing an authority to proceed with obtaining a registration certificate of the auxiliary key. A second request is received at the registration station at a second point in time that is subsequent to the first point in time, the second request providing the authority to obtain the registration certificate of the auxiliary key.

In another embodiment, a method for operating a cryptosystem having a user, a registration station, and an authentication station is disclosed. The user has been assigned an active key pair, the active key pair including a private key and a public key. The method comprises generating an at least one new security key for the user upon receiving a request to generate the at least one new security key; storing the generated new security key in a storage area without activating the new security key, the new security key being stored as an auxiliary key for the user; receiving a request to activate the new security key that is stored in the storage area from the user; and activating the new security key for the user after receiving the activation request from the user.

In yet another embodiment, a computer readable medium for use in a cryptosystem including a user, a registration station, and an authentication station is disclosed. The user has been assigned a first key pair. The first key pair includes a private key and a public key that have been activated. The medium comprises code for transmitting a first request to initiate registration of a second key for one of the users at the registration station at a first point in time while the first key pair is still active, the first request not providing an authority to proceed with obtaining a registration certificate of the second key; and code for transmitting a second request at the registration station at a second point in time that is subsequent to the first point in time, the second request providing the authority to obtain the registration certificate of the second key.

### BRIEF DESCRIPTION OF THE DRAWINGS

FIG. 1A is a schematic diagram showing a cryptosystem including a plurality of user terminals, a registration station server, and an authentication station server according to one embodiment of the present invention;

FIG. 1B depicts a security key database stored in a registration server of a cryptosystem according to one embodiment of the present invention.

FIG. 2 is a flowchart showing a method for generating and certifying a security key using a registration station server according to one embodiment of the present invention;

FIG. 3 is a flowchart showing a method for generating and certifying a security key using a registration station server according to one embodiment of the present invention, where a user generates and stores an auxiliary key;

FIG. 4 is a flowchart showing a method for generating and certifying a security key using a registration station server according to one embodiment of the present invention, where a request to activate an auxiliary key is required to commence using the auxiliary key as a new active key;

FIG. 5 shows a Web page screen provided by a registration station server to facilitate the generation of an auxiliary key according to one embodiment of the present invention.

FIG. 6A is a schematic diagram showing a cryptosystem including a plurality of user terminals, a registration station server, and an authentication station server according to another embodiment of the present invention;

FIG. 6B is a flowchart showing a method for generating and certifying a security key using a registration station server using an user notification function according to another embodiment of the present invention;

FIG. 6C is a flowchart showing a method for alerting a user to activate an auxiliary key according to one embodiment of the present invention;

### DETAILED DESCRIPTION OF THE INVENTION

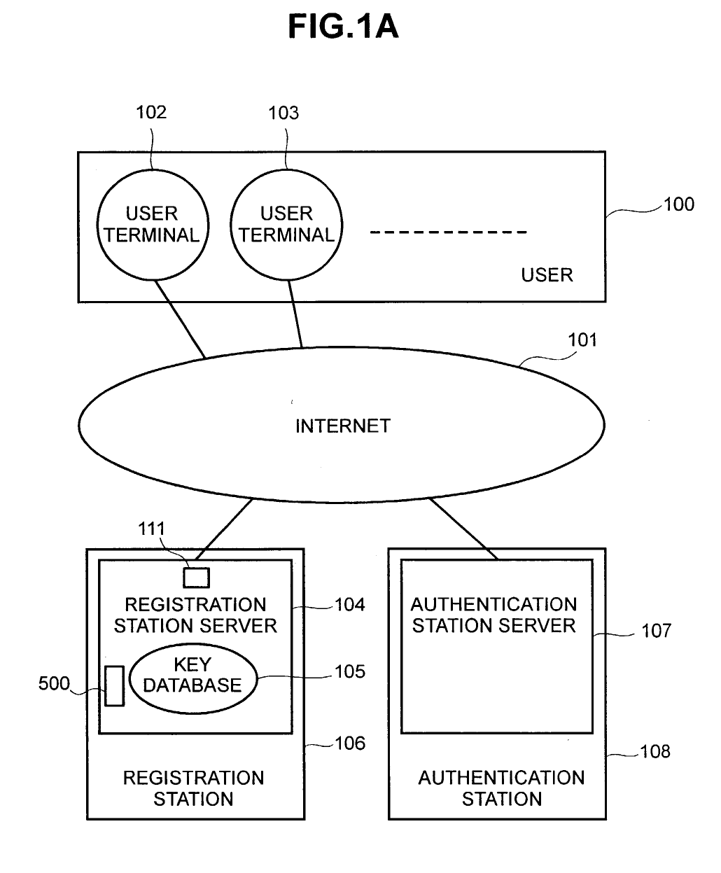

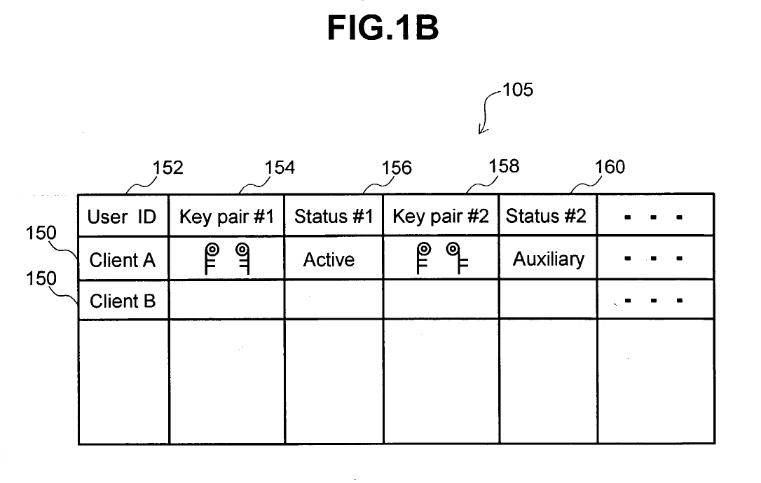

FIG. 1A shows a public key cryptosystem using communication means such as a network 101.

The method employs user terminals 102 and 103 operated by one or more users 100, a registration station server 104 installed in a registration station 106, and an authentication station server 107 installed in an authentication station 108. The registration station server 104 and the authentication station server 107 may be installed in different departments of a same station and connected to each other by way of a LAN. Furthermore, the function of each server may be realized by operating a plurality of servers in harmony to act as a single server.

Even though the network 101 can be a personal computer communication line, a LAN, an ATM circuit, a radio-communication network, etc., the following embodiments assume that the network 101 is made up of the Internet.

The registration station server 104 includes data to provide its Web page 500 accessible via the Internet. The registration station server 104 is provided with a network interface 111 coupled to the network 101, a key-pair generation capability and a key database 105, and generates and stores a key pair based on input information transmitted from a user terminal using the Web page 500 via the Internet.

The authentication station server 107 has a function to, upon receiving from the registration station server 104 a public key and a request for issuance of a digital certificate for the public key, issue the digital certificate so as to authorize the public key, making the key available to the user 100.

FIG. 1B depicts the key database 105 according to one embodiment of the present invention. The database 105 includes a plurality of rows or records 150 corresponding to a plurality of users. The record 150 includes a user ID section 152, a first key pair section 154 including or pointing the first key pair, a first status section 156 providing status information on the first key pair, a second key pair 158 including or pointing to the second key pair, and a second status section 160 providing status information on the second key pair. The status sections 156 and 160 provide information about whether the corresponding key pair is being currently used (active), is currently inactive (auxiliary) or has been deactivated (invalid).

### First Embodiment

The registration station server 104 includes the key database 105 in operation. The database 105 stores: user information including user IDs; current key pairs used for a public key cryptosystem; digital certificates for the current public keys; auxiliary key pairs; digital certificates for the auxiliary public keys; and examination information on new keys. They are stored in association with one another.

As described above, both a secret or private key and a public key (together comprising a key pair) become more and more risky to use as the frequency and period of their use increase. The user 100 judges how risky it is to use these keys based on their use frequency, etc., and determines, at a certain time point, that it is time to prepare auxiliary keys. Then, the user 100 accesses the Web page 500 through the user terminal 102 and prepares new public and secret keys as auxiliary public and secret keys. This arrangement eliminates the need for preparing the auxiliary keys at the time of the generation of the current public key regardless of risk involved in use of the current public key at that time, making it possible to reduce the cost for managing redundant auxiliary keys. Furthermore, since the use of the auxiliary keys starts at the same time when they are generated, their (predetermined) period of validity can be fully utilized. In addition, only one current public key exists at a time, making it possible to reduce the cost for managing a plurality of public keys and the cost for issuing digital certificates.

Accordingly, the database 105 for the present embodiment would not include the second key pair when the first key pair is created initially. The second key pair information is provided in the database 105 subsequently after the registration of the auxiliary key pair has been requested by the user.

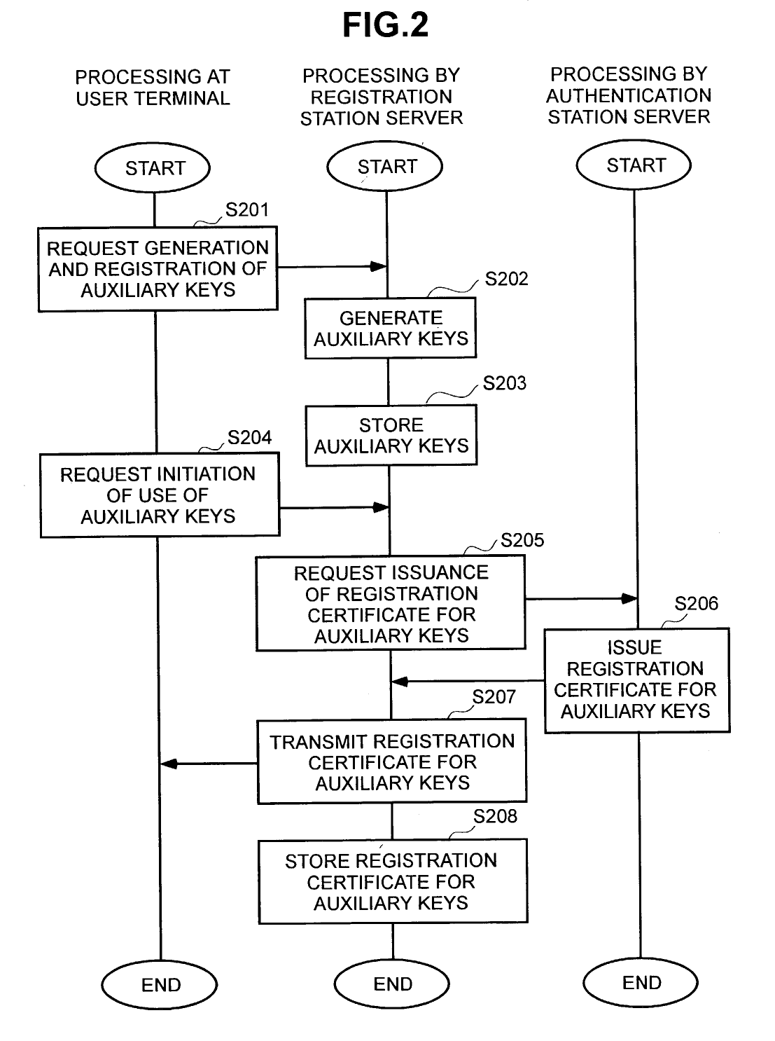

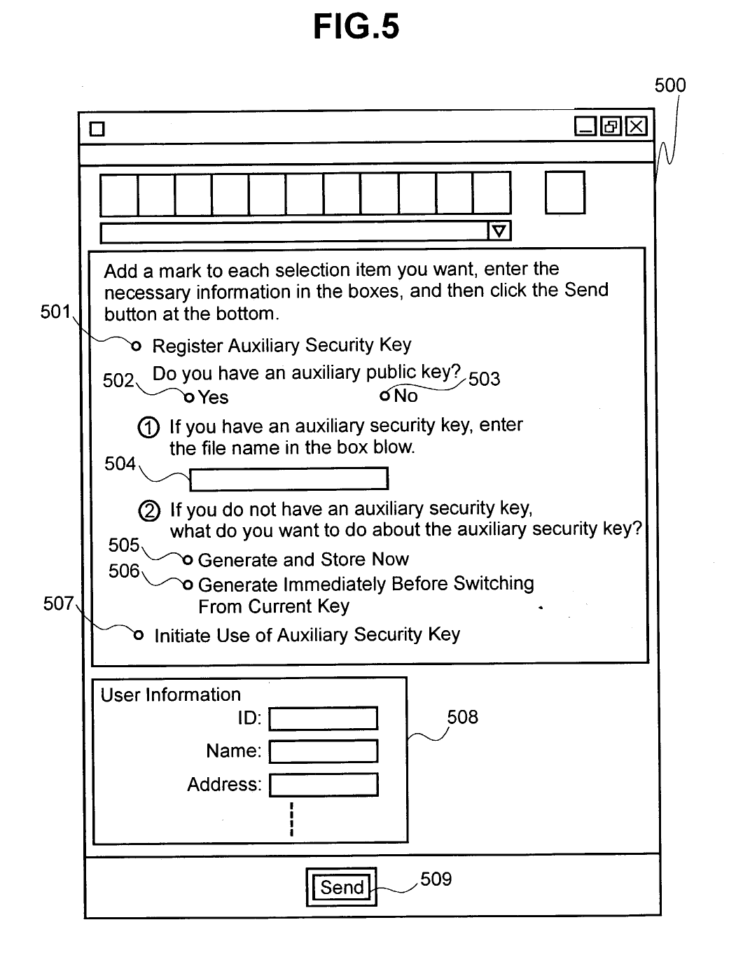

FIG. 2 is a flowchart showing steps employed by a method for using a registration station server according to a first embodiment of the present invention. FIG. 5 shows an example of the Web page 500 of the registration station server 104.

As shown in FIG. 2, on the Web page 500 of the registration station server 104, the user 100 clicks items 501, 503, and 505 labeled with “Register Auxiliary security Key”, “Do you have an auxiliary security key?—No”, and “Generate and Store Now”, respectively, and further clicks a Send button 509 from the user terminal 102 to transmit the selection results to the registration station server 104, at step S201. In response, the registration station server 104 searches the key database 105 using the transmitted user ID to obtain stored user information, information on the current public key, active private key, etc. On the other hand, the user submits documents necessary for authentication, such as a certified copy of register and a seal registration certificate, to the registration station server 104 by mail or electronically. The registration station 106 carries out the examination to identify the user and verify the authenticity of the submitted information based on the obtained information. It should be noted that this examination process takes the long time in the entire digital certificate issuance process for a public key. If the authentication is successful, the registration station server 104 generates a key pair at step S202, and stores it in the key database 105 in such a way that the key pair is associated with the user ID, at step S203. At that time, the registration station server 104 may transmit the newly generated secret key to the user terminal 102.

When the user has determined that the current secret key has become risky to use, the user accesses the Web page 500 through the user terminal 102 and clicks an item 507 labeled with “Initiate Use of Auxiliary Security Key” to transmit a request for initiation of use of an auxiliary key, at step S204. Upon receiving the request, the registration station server 104 transmits to the authentication station server 107 the (auxiliary) public key associated with the user ID, a request for invalidation of the current public key, and a request for issuance of a digital certificate for the auxiliary keys at step S205.

Then, the authentication station server 107 invalidates the digital certificate for the current public key, issues the requested digital certificate for the (auxiliary) public key, and transmits it to the registration station server 104 at step S206. Upon receiving the digital certificate, the registration station server 104 transmits the digital certificate for the public key to the user terminal 102 at step S207, and stores the user information and the public key digital certificate in the key database 105 in such a way that they are associated with the user ID at step S208. In the case where the registration station server 104 has generated the secret key, the registration station server 104 may transmit it together with the user information and the public key digital certificate at this stage.

Receiving the public key digital certificate, the user terminal 102 overwrites the digital certificate for the current public key in the memory with the received digital certificate.

### Second Embodiment

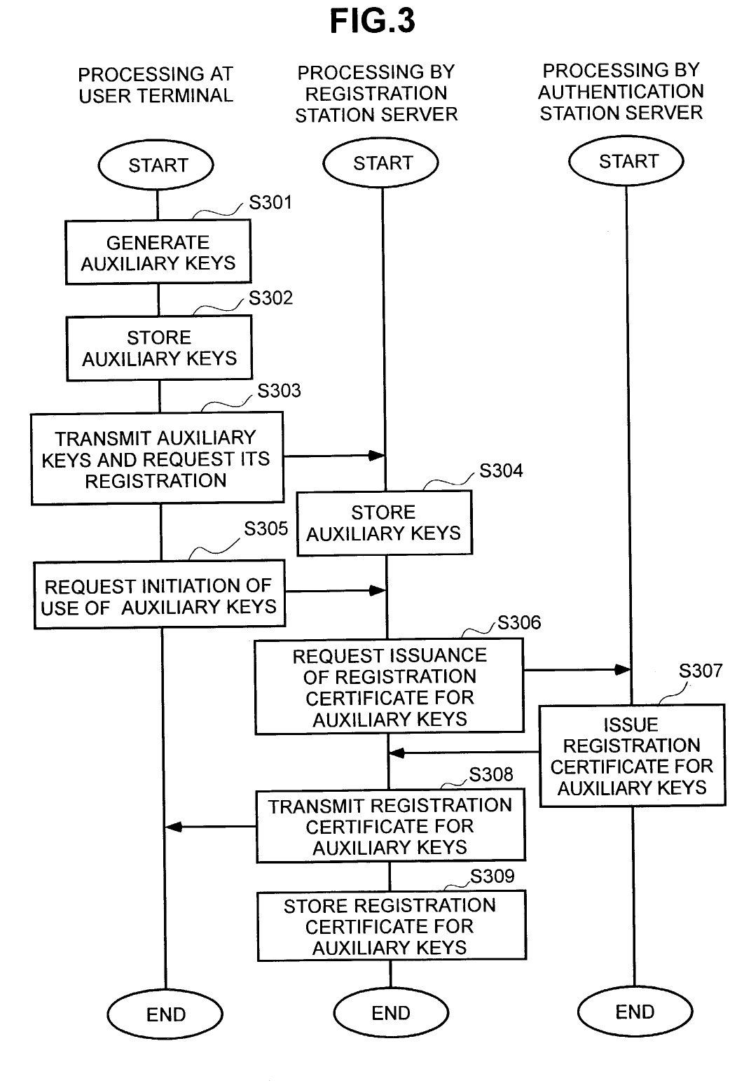

As shown in FIG. 3, a key pair (auxiliary key pair) may be generated by the user. In this case, the user 100 generates a key pair (step S301) and stores it (step S302). The user may store the key pair by himself or herself, or leave it to a third party. If the user stores the auxiliary key pair by himself or herself, the user preferably stores it in a memory area different from that storing the current key pair in the user terminal 102.

When registering the auxiliary key, on the Web page 500 of the registration station server 104, the user clicks items 501 and 502 labeled with “Register Auxiliary Key” and “Do you have an auxiliary key?—Yes”, respectively, enters user information in a field 508 and a file name in a box 504 (which specifies the security key), and clicks the Send button 509 to transmit the input information, at step S303. The registration station 106 carries out the same examination as that described above based on the user information transmitted from the user terminal 102 to the registration station server 104. If the examination was successful, the registration station server 104 stores the transmitted keys in the database 105 in such a way that it is associated with the user ID at step S304. In one implementation, only the public key is stored in the registration server. In another implementation, only the public key needs to be certified.

When the user has determined that the current secret key has become risky to use, the user requests initiation of use of the auxiliary public key through the user terminal 102. After that, the same processing as that for the first embodiment is performed until the user receives a digital certificate for the auxiliary key pair.

In this embodiment, the auxiliary key pair (or just the private key) is stored in an area different from that storing the current public key, as described above. Therefore, if there is a pointer pointing to the current private key, it is necessary to change the pointer, so that it points to the newly validated private key. Specifically, the user terminal 102 changes the address stored in the pointer so that the address, which indicates the area in the memory where the current private key is stored, is replaced by the address, which indicates the area in the memory where the new private key is stored.

### Third Embodiment

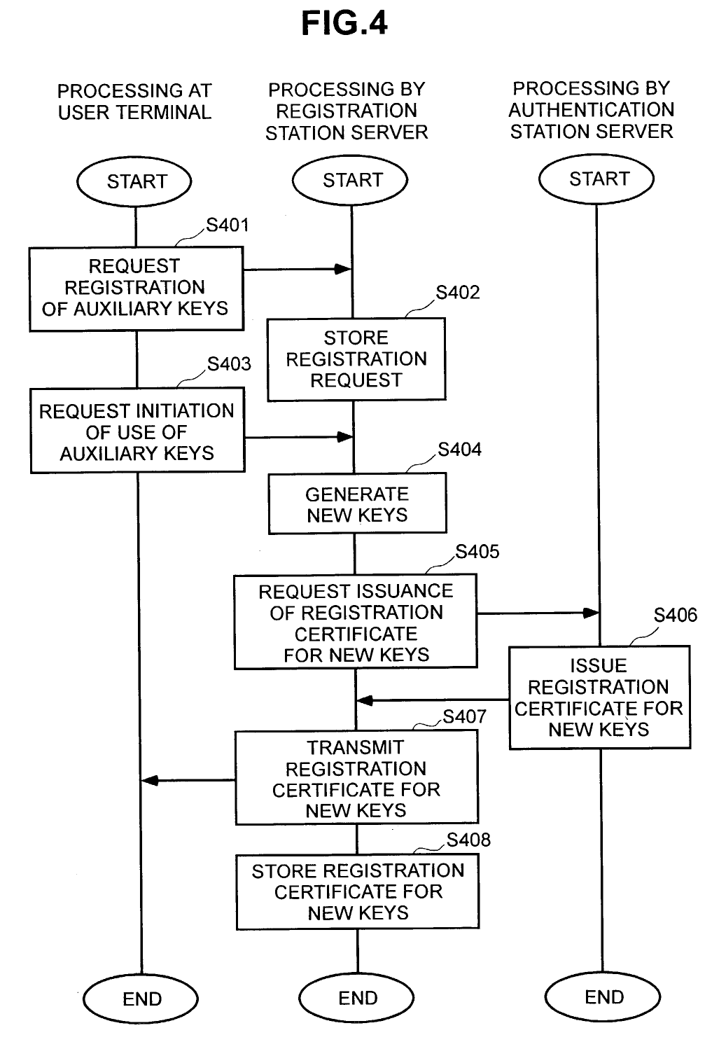

The present embodiment may be arranged such that the registration station server 104 does not prepare an auxiliary key pair but carries out the examination. In this case, an auxiliary key pair is generated when the current key pair needs to be replaced. Since the key generation process does not take much time and the examination has been already carried out, switching to the new key pair may be performed quickly. A third embodiment will be described below in detail with reference to the flowchart of FIG. 4.

According to the present embodiment, when the user 100 has determined that it is time to prepare an auxiliary key pair, the user 100 accesses the Web page 500 of the registration station server 104 through the user terminal 102, clicks items 501, 503, and 506 labeled with “Register Auxiliary Keys”, “Do you have an auxiliary key?—No”, and “Generate Immediately Before Switching From Current Key”, respectively, and then transmits the selection results, together with user information at step S401. The registration station 106 carries out an examination in the same way as described above based on the user information transmitted from the user terminal 102 to the registration station server 104. If the examination was successful, the registration station server 104 stores the transmitted registration request in such a way that it is associated with the user ID, at step S402. This arrangement can produce the same effect as that of the first embodiment as follows. This arrangement eliminates the need for preparing auxiliary keys at the time of the generation of the current key pair, making it possible to reduce the cost for managing redundant auxiliary keys. Furthermore, since use of the auxiliary keys is initiated when they are generated (not some time after they are generated), their (predetermined) valid use period can be fully utilized. For example, if each key pair is given a period of validity for two years from the time of its generation, then that two years can be fully utilized under the present embodiment unlike in the conventional method where the auxiliary key pair is generated together with the current key pair. In addition, since one current public key exists at a time, the additional cost for managing a plurality of key pairs is eliminated.

When the current secret key has become risky to use, the user accesses the same Web page 500 through the user terminal 102 and transmits a request for initiation of use of the auxiliary key pair at step S403. Upon receiving this request, the registration station server 104 first generates a new key pair at step S404, and transmits the new key pair associated with the user ID to the authentication station server 107 along with a request for issuance of a digital certificate for the new key pair and a request for invalidation of the current key pair at step S405. In one embodiment, only one of the new private key and public key is transmitted to the authentication server 107 at the step S405. In one embodiment, the request for invalidation of the current key pair is deemed to be inherent in the request for issuance of a digital certificate for the new key pair.

The authentication station server 107 invalidates the digital certificate for the current key pair, issues the requested digital certificate, and then transmits it to the registration station server 104 at step S406. Upon receiving the digital certificate, the registration station server 104 transmits the generated secret key and the digital certificate for the public key to the user terminal 102 at step S407. The registration station server 104 also stores the user information and the digital certificate for the new public key in the key database 105 in such a way that they are associated with the user ID, at step S408.

In all the embodiments described above, when the current secret key is believed have been compromised and too risky to use, an authorized third party, e.g., an administrator of the registration server, submit a request for invalidation of the current or active public key and activate the auxiliary keys. Also in this case, since the examination for issuing (receiving) the digital certificate has been already completed, the registration station server 104 can immediately transmit to the authentication station server 107 the (new) public key associated with the user ID, a request for invalidation of the current public key, and a request for issuance of a digital certificate for the new public key upon receiving the above invalidation request. Thus, the new public key can be quickly issued.

Further in the embodiment described above, after receiving the digital certificate from the authentication station server 107, the registration station server 104 may send an issuance notification of the digital certificate to the user terminal 102, instead of the digital certificate itself. In this case, the digital certificate is either stored in the registration station server 104 or sent to another user terminal or another server. Therefore, the user terminal 102 obtains the digital certificate by transmitting a digital certificate transfer request to the another user terminal or the server storing it, and receiving the digital certificate therefrom.

### Fourth Embodiment

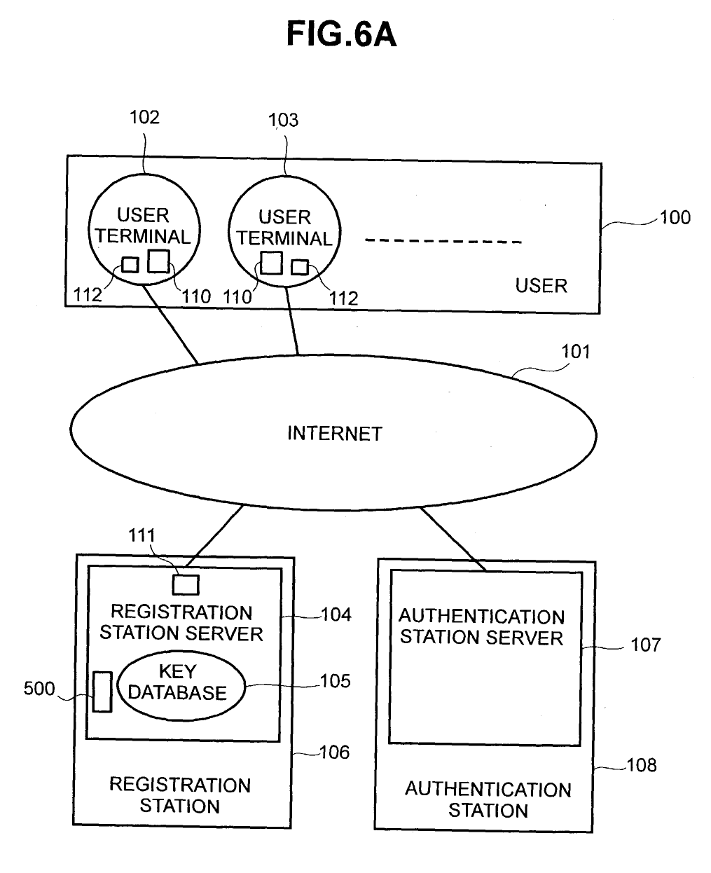

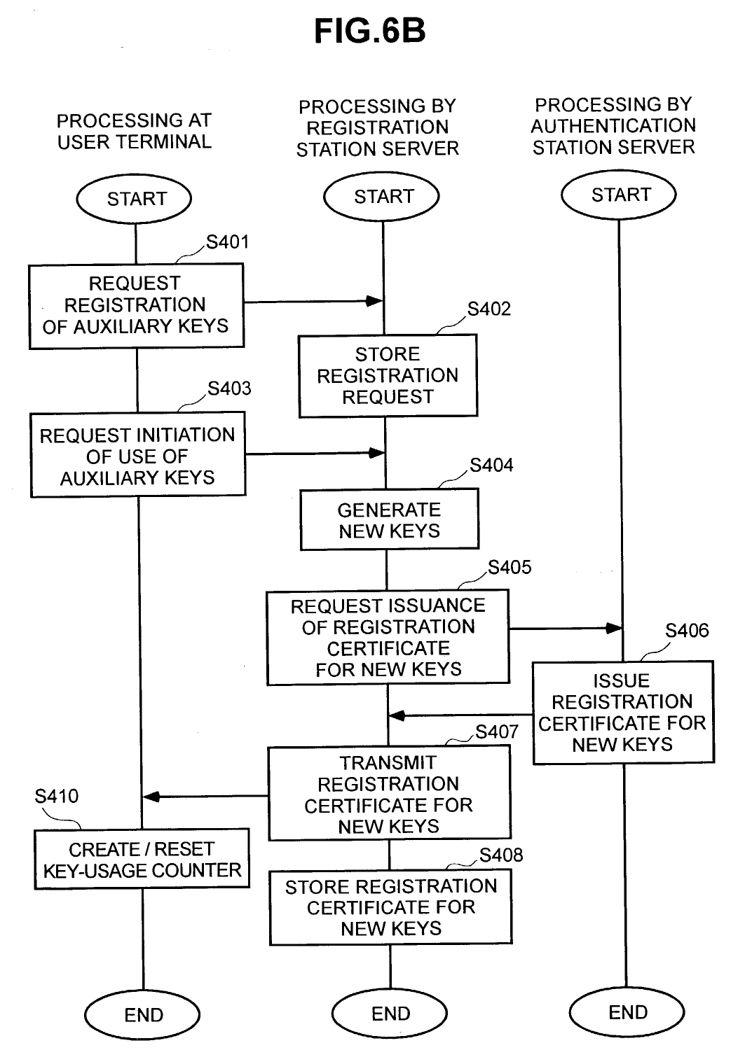

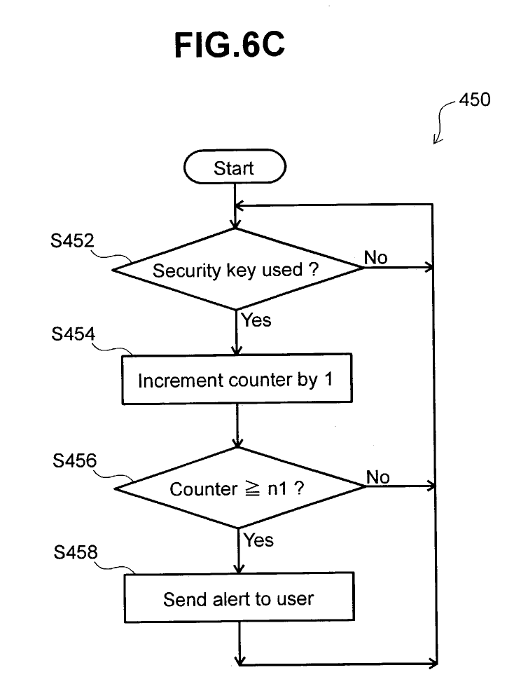

FIGS. 6A-6C illustrates a cryptosystem having a risk determination program 110 according to one embodiment of the present invention. Referring to FIG. 6A, the user device, e.g., the user terminal 102, includes the risk determination program 110 that automatically (e.g., without user input or intervention after the initial activation) alerts the user or an appropriate administrator if the risk of using the current key pair becomes unacceptably high. Alternatively, the risk determination program 110 may be included in the registration server 110.

Generally, the security risk of using the key pair increases with the increased usage of the key pair since more information about the key pair would be available each time it is used. Also, the risk of security breach increases as the encoded messages are sent to increased number of recipients since the danger of having provided information about the user's keys to a hacker increases proportionally. The risk level also depends on the type of keys used, e.g., the key algorithm and key length (1024 bits vs. 512 bits).

Based on these and other factors, the program 110 generates and sends a risk alert to the user if the security breach of using the current key pair becomes unacceptably high. FIGS. 6B and 6C depicts one method of using the program 110. The method described in FIG. 6B is similar to that described in the third embodiment using FIG. 4. One difference is that a key-usage counter 112 is created at the user device when the auxiliary key pair is activated, e.g., upon receiving the registration certification for the new keys (S410). The counter 112 keeps track of the number of times the new key pair is used by the user, as explained in more detail below. In one embodiment, an existing counter that was generated when the user first created his or her first key pair is reset at S410 instead of creating a new counter.

Referring to FIG. 5C, a process 450 uses the program 110 checks whether or not the security key, e.g., new private key, is used by the user to transmit a message to another person (S452). Alternatively, the program 110 may be activated at S452 only upon receiving a notification of use of the security key.

If the security key has been used, the counter 112 is incremented by 1 to indicate the key usage (S454). If the program 110 is provided in the user device, then the use of the private key is generally tracked. If the program 110 is in the registration server 104, then the use of the public key is generally tracked.

The program 110 determines whether or not the incremented counter is greater than or equal to a predetermined number N1 (S456). This predetermined number is a number of times that the user's key pair may be used with relative security. The value of N1 may be set by the user or the registration station or authentication station. The factors affecting the value of N1 are: the user's risk aversion, the user's use of the key pair, the type of the key pair used, and the like.

If the counter is greater than or equal to the predetermined number, than an alert is displayed to the user on the user terminal 102 informing him or her that the use of the current key pair has become unacceptably high, so that the user may initiate creation of a new auxiliary key pair to replace the current key pair (S458). In one embodiment, at S458, the program 110 initiates creation of an auxiliary key pair by itself and inform the user of creation thereof.

It should be noted that the present invention is not limited to the embodiments described above. Rather, these embodiments are presented to illustrate representative aspects of the present invention. Those skilled in the art will easily appreciate from the foregoing discussion and the appended figures and claims that the present invention can be easily applied, and various alterations, modifications, and variations may be made thereto without departing from the spirit and scope thereof as defined by the appended claims.

The present invention may be implemented in many different ways, as illustrated below.

One aspect of the present invention includes a method for using a registration station server. The method uses a public key cryptosystem employed in an environment where user terminals, an authentication station server, and the registration station server are connected in such a way that they can communicate with one another. The method includes the steps of: managing a current key pair by use of a database in such a way that they are associated with user IDs; upon receiving a request for registration of a new key pair from a user terminal A, searching the database using as a key a user ID received in attachment to the registration request, and if the user ID and a current key pair corresponding to the user ID exist (in the database), storing the new key pair in the database in such a way that the new key pair is associated with the user ID; upon receiving a request for initiation of use of the new key pair or a request for invalidation of the current key pair, transmitting to the authentication station server a request for issuance of a digital certificate for the new key pair, the initiation request and the invalidation request being sent from the user terminal A or another user terminal; and upon receiving the digital certificate for the new key pair sent from the authentication station server, transmitting the digital certificate to the user terminal A; wherein the above steps are performed by the registration station server.

The registration station server generates the new public key and a secret key corresponding to the new key pair, and transmits the secret key to the user terminal A, the user terminal A having requested registration of the new key pair.

Alternatively, the user terminal A generates the new public key and a secret key corresponding to the new key pair, stores the generated new public key and the generated secret key in a memory included in the user terminal A, and transmits the generated new key pair to the registration station server together with a request for registration of the generated new key pair.

According to another aspect of the present invention, a key management method for using a registration station server is provided. The method uses a public key cryptosystem employed in an environment where user terminals, an authentication station server, and the registration station server are connected in such a way that they can communicate with one another. The method for using a registration station server comprises the steps of: managing user IDs by use of a database; upon receiving a request for registration of a new key pair from a user terminal A, searching the database using as a key a user ID received in attachment to the registration request, and if the user ID exists (in the database), storing the registration request in the database in such a way that the registration request is associated with the user ID; upon receiving a request for initiation of use of the new key pair or a request for invalidation of a current key pair, transmitting to the authentication station server a request for issuance of a digital certificate for a newly generated key pair, the initiation request and the invalidation request being sent from the user terminal A or another user terminal; and upon receiving the digital certificate for the newly generated key pair sent from the authentication station server, transmitting the digital certificate to the user terminal A; wherein the above steps are performed by the registration station server.

Yet another aspect of the present invention provides a method for using a registration station server provided in a public key cryptosystem that is employed in an environment where user terminals, an authentication station server, and the registration station server are connected in such a way that they can communicate with one another. The method for using a registration station server comprises the steps of: managing a current key pair by use of a database in such a way that they are associated with user IDs; upon receiving a request for registration of a new key pair from a user terminal A, searching the database using as a key a user ID received in attachment to the registration request, and if the user ID and a current key pair corresponding to the user ID exist (in the database), storing the registration request in the database in such a way that the registration request is associated with the user ID; upon receiving a request for initiation of use of the new key pair or a request for invalidation of the current key pair, transmitting to the authentication station server a request for issuance of a digital certificate for a newly generated key pair, the initiation request and the invalidation request being sent from the user terminal A or another user terminal; upon receiving the digital certificate for the newly generated key pair sent from the authentication station server, transmitting the digital certificate to the user terminal A; wherein the above steps are performed by the registration station server.

Upon receiving the request for activation of the new key pair or the request for invalidation of the current key pair, the registration station server generates the new public key and a secret key corresponding to the new public key, and transmits the secret key to the user terminal A, the activation request and the invalidation request being sent from the user terminal A or another user terminal.

The above detailed descriptions are provided to illustrate specific embodiments of the present invention and are not intended to be limiting. Numerous modifications and variations within the scope of the present invention are possible. Accordingly, the present invention is defined by the appended claims.

What is claimed is:

1. A method for operating a cryptosystem having a user, a registration station, and an authentication station, the user having been assigned an active key pair, the active key pair including a private key and a public key, the method comprising:
generating an at least one new security key for the user upon receiving a request to generate the at least one new security key;
storing the generated new security key in a storage area without activating the new security key, the new security key being stored as an auxiliary key for the user;
receiving a request to activate the new security key that is stored in the storage area from the user; and
activating the new security key for the user after receiving the activation request from the user.

2. The method of claim 1, wherein the at least one new security key that is generated is a new key pair including a new private key and a new public key.

3. The method of claim 1, further comprising:
submitting a request for issuance of a registration certificate for the new security key to the authentication station upon receipt of the activation request from the user; and
generating the registration certificate for the new security key at the authentication station in response to the submitted request.

4. The method of claim 3, wherein the submitting-a-request step and the generating-the-the registration-certificate step are performed by the same entity.

5. The method of claim 3, wherein the submitting-a-request step is performed by the registration station and the generating-the-the registration-certificate step is performed by the authentication station, the registration and authentication stations being a first server and a second server.

6. The method of claim 5, further comprising:
transmitting the registration certificate received from the authentication station to the user from the registration station;
storing the registration certificate in a storage location controlled by the registration station; and
deactivating the active key pair of the user.

7. The method of claim 3, further comprising:
transmitting the registration certificate received to the user from the registration station with a private key corresponding to the at least one new security key.

8. The method of claim 1, wherein the new security key is generated at the registration station and the request to generate the at least one new security key is sent by the user to the registration station.

9. The method of claim 1, wherein the at least one new security key is generated in a user device in response to the request to generate the at least one security key and the generated at least one security key is stored in the user device.

10. A method for operating a cryptosystem having a user, a registration station, and an authentication station, the user having been assigned an active key pair, the active key pair including a private key and a public key, the method comprising:
receiving a first request to initiate registration of an auxiliary key for the user at the registration station at a first point in time, the first request not providing an authority to proceed with obtaining a registration certificate of the auxiliary key; and
receiving a second request at the registration station at a second point in time that is subsequent to the first point in time, the second request providing the authority to obtain the registration certificate of the auxiliary key.

11. The method of claim 10, further comprising:
authenticating the first request upon receiving the first request.

12. The method of claim 1 1, further comprising:
storing the first request upon validating the first request based on the authenticating step.

13. The method of claim 10, further comprising:
generating the auxiliary key; and
submitting a third request for issuance of a registration certificate for the generated auxiliary key to the authentication station upon receipt of the second request; and
generating the registration certificate for the auxiliary key at the authentication station in response to the third request.

14. The method of claim 13, wherein the auxiliary key is generated at the registration key upon receipt of the second request, wherein the first and second requests are from the user to the registration station, wherein the generating auxiliary key step includes generating an auxiliary private key and an auxiliary public key.

15. The method of claim 10, further comprising:
monitoring use of the active key pair by the user; and
alerting the user of a security risk of continued use of the active key pair if a predetermined condition is met based;
wherein the first request is transmitted by the user to the registration station upon receipt of the security risk alert,
wherein the registration station is a registration apparatus and an authentication station is an authentication apparatus.

16. A registration apparatus provided in a cryptosystem, the cryptosystem including a plurality of user terminals and a network coupling the user terminals to the registration apparatus, the apparatus comprising:
a network interface coupled to the network;
a database including information about a plurality of users and a plurality of key pairs assigned to the plurality of users;
a computer readable medium including:
code for receiving a first request to initiate registration of an auxiliary key for one of the users at the registration station at a first point in time, the first request not providing an authority to proceed with obtaining a registration certificate of the auxiliary key; and
code for receiving a second request at the registration station at a second point in time that is subsequent to the first point in time, the second request providing the authority to obtain the registration certificate of the auxiliary key.

17. The registration apparatus of claim 16, wherein registration apparatus is a server, the computer readable medium further includes:
code for generating the auxiliary key; and
code for submitting a third request for issuance of a registration certificate for the generated auxiliary key to an authentication station upon receipt of the second request.

18. The registration apparatus of claim 16, wherein the computer readable medium further includes:
code for alerting the user of a security risk of continued use of the active key pair upon determining that a predetermined condition has been met.

19. A computer readable medium for use in a cryptosystem including a user, a registration station, and a authentication station, the user having been assigned an active key pair, the active key pair including a private key and a public key, the medium comprising:
code for receiving a first request to initiate registration of an auxiliary key for one of the users at the registration station at a first point in time, the first request not providing an authority to proceed with obtaining a registration certificate of the auxiliary key; and
code for receiving a second request at the registration station at a second point in time that is subsequent to the first point in time, the second request providing the authority to obtain the registration certificate of the auxiliary key.

20. The computer readable medium of claim 19, further comprising:
code for generating the auxiliary key for the user upon receiving the first request;
code storing the generated auxiliary key in a storage area without activating the auxiliary key; and
code for activating the new security key for the user after receiving the second request.

21. A computer readable medium for use in a cryptosystem including a user, a registration station, and an authentication station, the user having been assigned a first key pair, the first key pair including a private key and a public key and having been activated, the medium comprising:
code for transmitting a first request to initiate registration of a second key for one of the users at the registration station at a first point in time while the first key pair is still active, the first request not providing an authority to proceed with obtaining a registration certificate of the second key; and
code for transmitting a second request at the registration station at a second point in time that is subsequent to the first point in time, the second request providing the authority to obtain the registration certificate of the second key.
